(19) United States
(12) Patent Application Publication
(10) Pub. No.: US 2009/0092372 A1
(43) Pub. Date: Apr. 9, 2009

(54) Information reproduction device

(75) Inventor: Tokuaki Utunomiya, Osaka (JP)

Correspondence Address: MORGAN LEWIS & BOCKIUS LLP, 1111 PENNSYLVANIA AVENUE NW, WASHINGTON, DC, 20004, US

(73) Assignee: FUNAI ELECTRIC CO., LTD.

(21) Appl. No.: 12/285,405

(22) Filed: Oct. 3, 2008

(30) Foreign Application Priority Data
Oct. 4, 2007 (JP) 2007-260549

(51) Int. Cl. H04N 5/93

(52) U.S. Cl. 386/52

(57) ABSTRACT

An information reproduction device capable of information reproduction from a recording medium (1) in which at least moving image files and sound files are recorded includes: a sound file selection window display part (121) which, when plural sounds select function has been set, after detection that a desired moving image file has been selected from a reproduction list window (31), when there is a sound file corresponding to the desired moving image file in a same holder of the desired moving image file, displays a sound file selection window (14) on a display device (16); and a simultaneous reproduction part (122) which, upon detection that a desired sound file has been selected from the sound file selection window (41) displayed by the sound file selection window display part (121), simultaneously reproduces the selected desired moving image file and the selected desired sound file.

This application is based on Japanese Patent Application No. 2007-260549 filed on Oct. 4, 2007, the contents of which are hereby incorporated by reference.

### BACKGROUND OF THE INVENTION

1. Field of the Invention

The present invention relates to an information reproduction device capable of performing information reproduction from a recording medium in which at least moving image files and sound files are recorded.

2. Description of Related Arts

Conventionally, an information reproduction device of this type reads a moving image file and a sound file recorded on a recording medium such as a DVD or a CD, displays a reproduced video on a display device in a monitor device such as a TV receiver, and also outputs a reproduced sound from a sound output device.

Known as a format of a sound file are MP3 (MPEG Audio Layer-3), MP2 (MPEG Audio Layer-2), ATRAC (Adaptive Transform Acoustic Coding), etc. Moreover, known as a format of a moving image file are: AVI or Divx (registered trademark) without sound data.

Here, processing for reproducing a moving image file and a sound file recorded on the recording medium in a conventional information reproduction device such as the reproduction device described in JP-A-2005-251340 will be described.

First, to select a moving image file desired to be reproduced from among a plurality of moving image files recorded on the recording medium, the user operates a key for displaying a reproduction list on an operation part, upon which a system controller detects that instructions for displaying a reproduction list have been provided, reads file management information on the recording medium, and in accordance with this file management information, displays a reproduction list window on a display device of a monitor device.

Then the user views a reproduction list window, operates the operation part, and selects and determines a moving image file name of the desired moving image file, upon which the system controller reads the file management information on the recording medium. Then in accordance with this file management information, the system controller reads from the recording medium a sound file with a sound file name corresponding to the selected moving image file name described above, and simultaneously reproduces the moving image file and the sound file corresponding to this moving image file. Then when this reproduction ends, this processing ends.

However, in the conventional information reproduction device, a sound file for one moving image file is basically only one sound file previously defined. Thus, there arises a problem that another desired sound file cannot be selected and reproduced for this moving image file. Moreover, since another desired sound file cannot be reproduced during reproduction, there arises a problem of poor user friendliness.

With the conventional technology described in JP-A-2005-251340, sound/image files recorded on the recording medium are displayed on a listed menu, without depending on sound/image file formats; thus, the sound/image files recorded on the recording medium can be checked and reproduced without considering difference in the sound/image file format. However, for a moving image file such as AVI or Divx (registered trademark) without sound data, only a sound file previously defined can be simultaneously reproduced for one moving image file. Therefore, it is not disclosed that another desired sound file is selected and reproduced for such a moving image file and also that another desired sound file is selected and reproduced during reproduction.

### SUMMARY OF THE INVENTION

It is an object of the present invention to provide an information reproduction device capable of, to reproduce a moving image file without sound data, selecting a desired sound file corresponding to this moving image file from among a plurality of sound files and then simultaneously reproducing the moving image file and the sound file.

To achieve the object described above, according to one aspect of the invention, an information reproduction device capable of information reproduction from a recording medium in which at least moving image files and sound files are recorded includes: a sound file selection window display part which, when plural sounds select function has been set, after detection that a desired moving image file has been selected from a reproduction list window, when there is a sound file corresponding to the desired moving image file in a same holder of the desired moving image file, displays a sound file selection window on a display device; and a simultaneous reproduction part which, upon detection that a desired sound file has been selected from the sound file selection window displayed by the sound file selection window display part, simultaneously reproduces the selected desired moving image file and the selected desired sound file.

With this configuration, when the plural sounds select function is set, upon selection of the desired moving image file from the reproduction list window, when the sound file corresponding to the desired moving image file exists in the same folder for the desired moving image file, the sound file selection window is displayed on the display device. Then upon selection of the desired sound file from the displayed sound file selection window, the selected desired moving image file and the selected desired sound file are simultaneously reproduced.

With this configuration, to reproduce a moving image file without sound data, a desired sound file can be selected from among a plurality of sound files corresponding to this moving image file and then the moving image file and the sound file can be simultaneously reproduced, whereby even for a file in the file format that basically permits reproduction of only a sound file previously defined for one moving image file, another desired sound file can be selected and reproduced for this moving image file, thus improving the user-friendliness.

Preferably, the information reproduction device of one aspect of the invention further includes a during-reproduction corresponding-sound file selection-window display part which, upon detection of instructions for displaying the sound file selection window during the simultaneous reproduction of the moving image file and the sound file by the simultaneous reproduction part, displays the sound file selection window on the display device, in which output sound is switched by selecting another desired sound file other than the desired sound file in the displayed sound file selection window. Thus, the sound file can be switched even during reproduction, thus improving the user-friendliness.

Preferably, the information reproduction device of one aspect of the invention further includes a reproduction part which, upon detection that no sound file has been selected from the sound file selection window displayed by the sound file selection window display part, reproduces only the selected desired moving image file. Thus, when no sound file has been selected from the sound file selection window, only the selected desired moving image file can be reproduced.

Preferably, the information reproduction device of one aspect of the invention further includes a reproduction part, which, when the plural sounds select function has not been set, after the detection that the desired moving image file has been selected from the reproduction list window, reproduces only the selected desired moving image file. Thus, when the plural sounds select function is not set, upon the detection that the desired moving image file has been selected from the reproduction list window, only the selected desired moving image file can be reproduced.

As described above, with the information reproduction device of one aspect of the invention, to reproduce a moving image file without sound data, a desired sound file can be selected from a plurality of sound files corresponding to this moving image file and then the moving image file and the sound file can be simultaneously reproduced. Consequently, even for a file in the file format that basically permits reproduction of only a sound file previously defined for one moving image file, another desired sound file for this moving image file can be selected and reproduced, thus improving the user-friendliness.

Moreover, by selecting another desired sound file other than the desired sound file in the sound file selection window, output sound can be switched. Thus, even during the reproduction of the moving image file and the sound file, the sound file to be output can be switched, thus further improving the user friendliness.

### BRIEF DESCRIPTION OF THE DRAWINGS

FIG. 1 is a block diagram showing configuration of an information reproduction device according to first and second embodiments of the present invention;

FIG. 2 is a diagram showing one example in which a setup window for setting plural sounds select function is displayed on a display device in the first and second embodiments;

FIG. 3 is a diagram showing one example of a reproduction list window in the first and second embodiments;

FIG. 4 is a diagram showing one example of a sound file selection window in the first and second embodiments;

FIG. 5 is a diagram showing one example of the sound file selection window in the first and second embodiments;

FIG. 6 is a flow chart explaining processing for reproducing a moving image file and a sound file recorded on a recording medium in the first embodiment;

FIG. 7 is a flow chart explaining processing for reproducing a moving image file and a sound file recorded on a recording medium in the second embodiment;

### DETAILED DESCRIPTION OF PREFERRED EMBODIMENTS

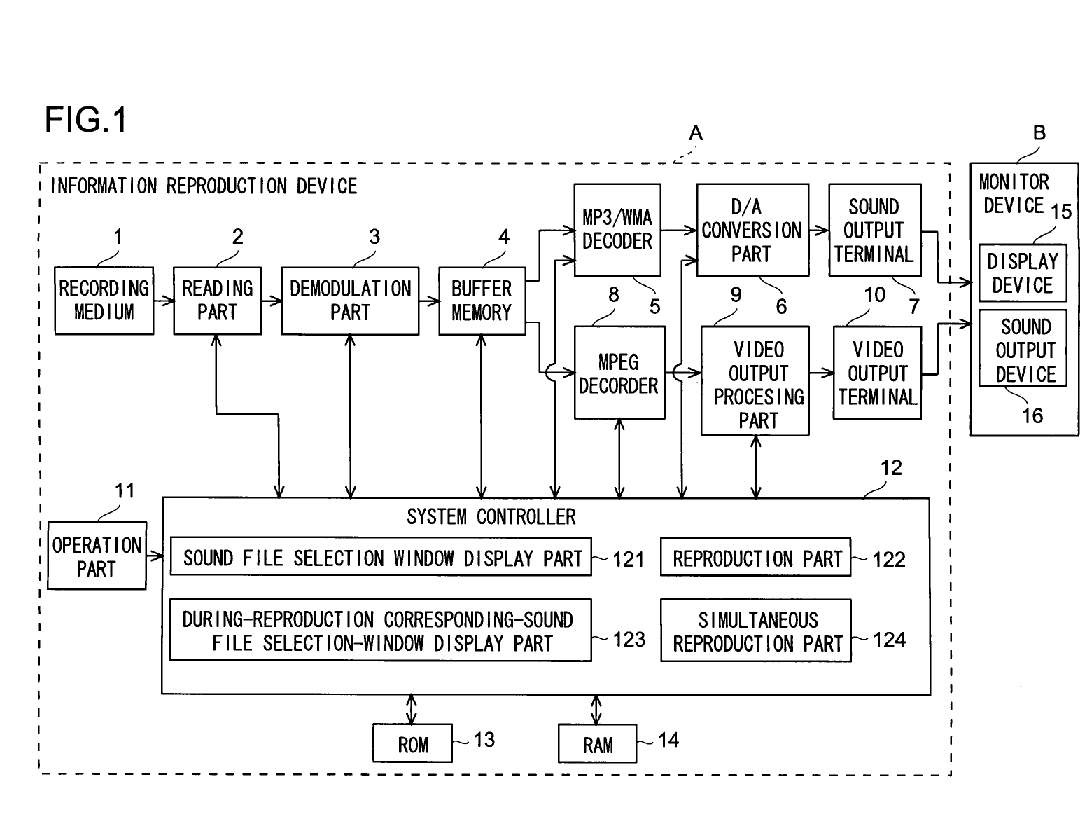

Hereinafter, referring to the accompanying drawings, the embodiments of the present invention will be described. FIG. 1 is a block diagram showing configuration of an information reproduction device according to first and second embodiments of the invention.

In FIG. 1, the information reproduction device A includes: a reading part 2 reading sound/moving image files from a recording medium 1 such as a DVD (Digital Versatile Disc), a BD (Blue-ray Disc), a CD (Compact Disc), or the like; a demodulation part 3 demodulating the read sound/moving image files; a buffer memory 4 temporarily storing the demodulated sound/moving image files; an MP3/WMA decoder 5 decoding the sound file temporarily stored; a D/A conversion part 6 converting digital data of the decoded sound file into an analog signal; and a sound output terminal 7 outputting a sound signal obtained through the conversion into the analog signal.

In addition, the information reproduction device A includes: an MPEG decoder 8 decoding the moving image file temporarily stored in the buffer memory 4; a video output processing part 9 converting a digital signal of the aforementioned decoded moving image file into a data format for displaying the moving image file on an external monitor device B; a video output terminal 10 outputting data of the moving image file processed at the video output processing part 9; an operation part 11 having a plurality of keys and outputting an operation signal in response to key pressing; a system controller 12 having a CPU for controlling the entire device; a ROM 13 storing programs and data required for calculation or processing by the aforementioned CPU; and a RAM 14 temporarily storing the data required for calculation and processing by the aforementioned CPU.

To the sound output terminal 7, an input terminal of a sound output device 15 of the monitor device B is connected, and to the video output terminal 10, an input terminal of a display device 16 of the monitor device B is connected.

The system controller 12 includes: as features of the first embodiment, a sound file selection window display part which, when plural sounds select function has been set, after detection that a desired moving image file has been selected from a reproduction list window, when a sound file corresponding to the desired moving image file is in the same folder of the aforementioned desired moving image file, displays a sound file selection window on the display device 16; a simultaneous reproduction part which, upon detection that a desired sound file has been selected from the sound file selection window displayed by the sound file selection window display part, simultaneously reproduces the selected desired moving image file and the selected desired sound file; and a reproduction part which, upon detection that no sound file has been selected from the sound file selection window displayed by the sound file selection window display part or upon detection that the desired moving image file has been selected from the reproduction list window when the plural sounds select function has not been set, reproduces only the selected desired moving image file.

Moreover, the system controller 12 includes: as features of the second embodiment, a sound file selection window display part which, when plural sounds select function has been set, after detection that a desired moving image file has been selected from a reproduction list window, when a sound file corresponding to the desired moving image file is in the same folder of the aforementioned desired moving image file, displays a sound file selection window on the display device 16; a simultaneous reproduction part which, upon detection that a desired sound file has been selected from the sound file selection window displayed by the sound file selection window display part, simultaneously reproduces the selected desired moving image file and the selected desired sound file; a during-reproduction corresponding-sound file selection-window display part which, upon detection of instructions for displaying the sound file selection window during the simultaneous reproduction of the selected desired moving image file and the selected desired sound file by the simultaneous reproduction part, displays the sound file selection window on the display device 16; and a reproduction part which, upon detection that no sound file has been selected from the sound file selection window displayed by the sound file selection window display part or upon detection that the desired moving image file has been selected from the reproduction list window when the plural sounds select function has not been set, reproduces only the selected desired moving image file.

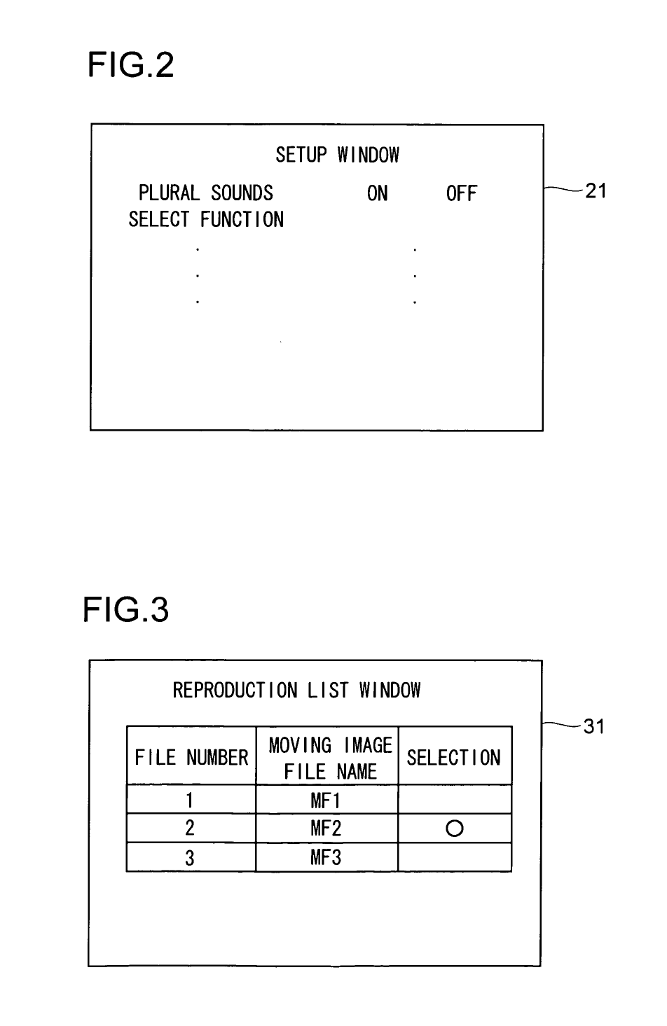

FIG. 2 is a diagram showing one example in which a setup window for setting the plural sounds select function is displayed on the display device in the first and second embodiments. Displayed on this setup window 21 are: an item “plural sounds select function”; an “ON” button for setting such that the plural sounds select function is activated; and an “OFF” button for setting such that the plural sounds select function is not activated. On the setup window 21, other functions are also displayed but are omitted here.

FIG. 3 is a diagram showing one example of a reproduction list window in the first and second embodiments. On this reproduction list window 31, file numbers of moving image files recorded on the recording medium, moving image file names of the moving image files, and a circle mark indicating which is the selected moving image file. Here, it is indicated that the moving image file with the file number “2” and the file name “MF2” has been selected.

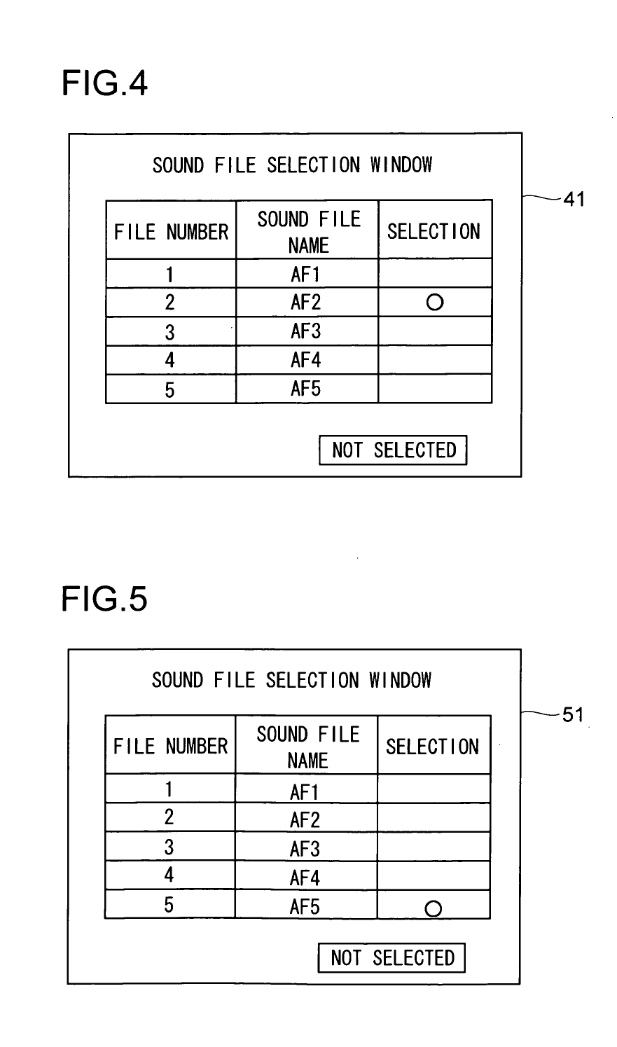

FIG. 4 is a diagram showing one example of the sound file selection window in the first and second embodiments. Displayed on this sound file selection window 41 are: file numbers of sound files recorded on the recording medium; sound file names of the sound files; and a circle mark indicating which is the selected sound file. Here, it is indicated that the sound file with the file number is “2” and the sound file name “AF2” has been selected. When none of the sound files AF1 to AF5 is selected, an item “not selected” is selected.

FIG. 5 is a diagram showing one example of the sound file selection window in the first and second embodiments. Displayed on this sound file selection window 51 are: file numbers of the sound files recorded on the recording medium; sound file names of the sound files; and a circle mark indicating which is the selected sound file. Here, it is indicated that the sound file with the sound file number “5” and the sound file name “AF5” has been selected. When none of the sound files AF1 to AF5 is selected, an item “not selected” is selected.

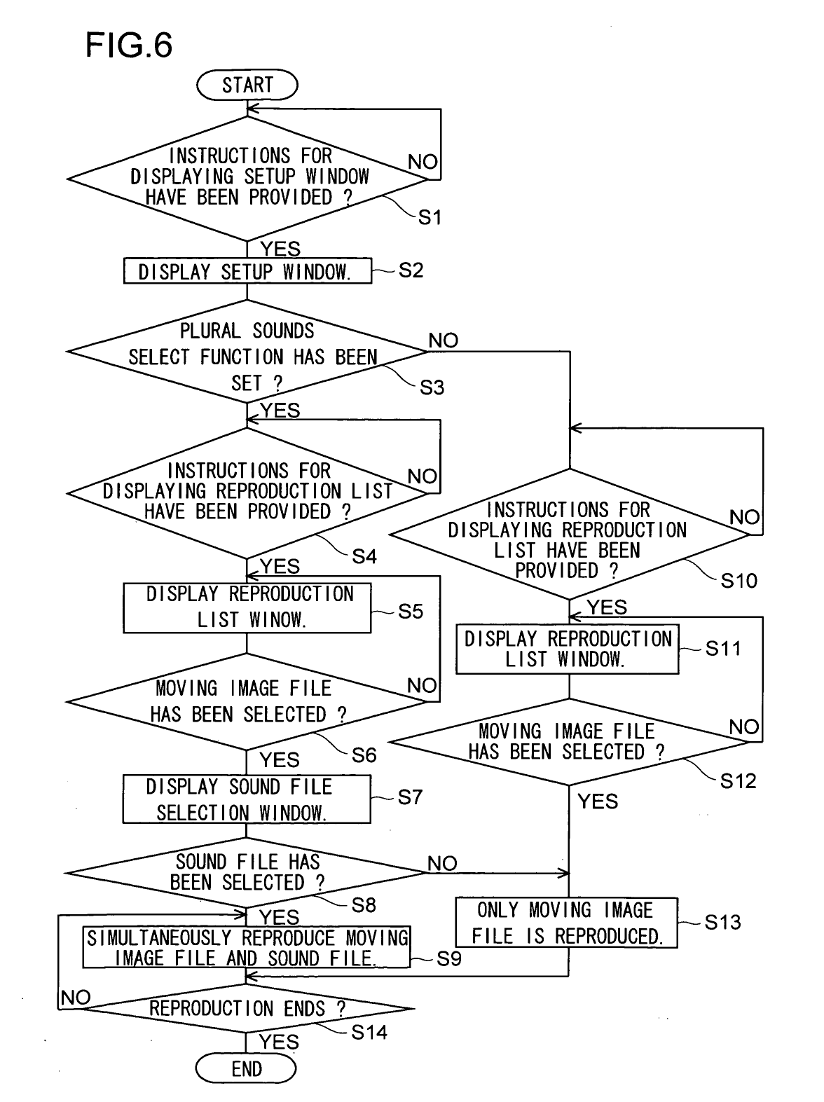

FIG. 6 is a flow chart explaining processing performed when the information reproduction device in the first embodiment reproduces a moving image file and a sound file recorded on the recording medium. Referring to this flowchart and FIGS. 1 to 5, a description will be given, concerning the processing performed when the information reproduction device in this embodiment reproduces a moving image file and a sound file recorded on the recording medium.

First, to display the setup window 21 on the display device 16 of the monitor device B, the user operates a key for displaying the setup window on the operation part 11, upon which the system controller 12 detects that instructions for displaying the setup window have been provided (step S1), and displays, for example, the setup window 21 on the display device 16 of the monitor device B (step S2).

The user views the setup window 21, and in order to activate the plural sounds select function, operates a cursor key on the operation part 11 to select the “ON” button and further operates a determine key on the operation part 11. Then the system controller 12 detects that the plural sounds select function has been set (step S3).

Next, the user, in order to select a moving image file desired to be reproduced from among a plurality of moving image files recorded on the recording medium 1, operates a key for displaying the reproduction list on the operation part 11. Then the system controller 12 detects that instructions for displaying the reproduction list have been provided (step S4), reads file management information recorded on the recording medium 1, and in accordance with this file management information, displays the reproduction list window 31 on the display device 16 of the monitor device B (step S5).

Then the user views the reproduction list window 31, operates the operation part 11 to select and determine, for example, the moving image file name “MF2”, upon which the sound file selection window display part of the system controller 12 detects that the moving image file with the file name “MF2” has been selected (step S6), and when a sound file corresponding to the moving image file with the moving image file name “MF2” exists in the same holder of this moving image file, displays the sound file selection window 41 on the display device 16 (step S7).

Further, the user views the sound file selection window 41, and operates the operation part 11 to select and determine, for example, the sound file name “AF2”, upon which the simultaneous reproduction part of the system controller 12 detects that the sound file with the sound file name “AF2” has been selected (step S8), and simultaneously reproduces the aforementioned moving image file and the aforementioned selected sound file which have been selected from the recording medium 1 (step S9). Then when this reproduction ends (step S14), this processing ends.

Moreover, the user views the setup window 21, and when the user does not desire to activate the plural sounds select function, operates the cursor key on the operation part 11 to select an “OFF” button, and further operates the determine key on the operation part 11, upon which the system controller 12 detects that the plural sounds select functions has not been set (step S3).

Next, the user, in order to select the moving image file desired to be reproduced from among the plurality of moving image files recorded on the recording medium 1, operates the key for displaying the reproduction list on the operation part 11. Then the system controller 12 detects that instructions for displaying the reproduction list have been provided (step S10), reads the file management information recorded on the recording medium 1, and in accordance with this file management information, displays, for example, the reproduction list window 31 on the display device 16 of the monitor device B (step S11).

Then the user views the reproduction list window 31, and operates the operation part 11 to select and determine, for example, the moving file name “MF2”, upon which the reproduction part of the system controller 12 detects that the moving image file with the moving image file name “MF2” has been selected (step S12), and reproduces from the recording medium 1 only the moving image file with the moving image file name “MF2” (step S13). Then when this reproduction ends (step S14), this processing ends.

Moreover, in step S8, for example, the sound file name is not selected on the sound file selection window 41 (see FIG. 4), and the item “not selected” is selected by operating the cursor key on the operation part 11 and determined by operating the determine key on the operation part 11, upon which the reproduction part of the system controller 12 detects that no sound file has been selected from the sound file selection window 41 (step S8), and reproduces only the moving image file with the moving image file name “MF2” (step S13). Then when this reproduction ends (step S14), this processing ends.

With the information reproduction device of the first embodiment described above, to reproduce a moving image file without sound data, a desired sound file can be selected from among a plurality of sound files corresponding to this moving image file and then the moving image file and the sound file can be simultaneously reproduced, whereby even for a file in the file format that basically permits reproduction of only a sound file previously defined for one moving image file, another desired sound file for this moving image file can be selected and reproduced, thus improving the user-friendliness.

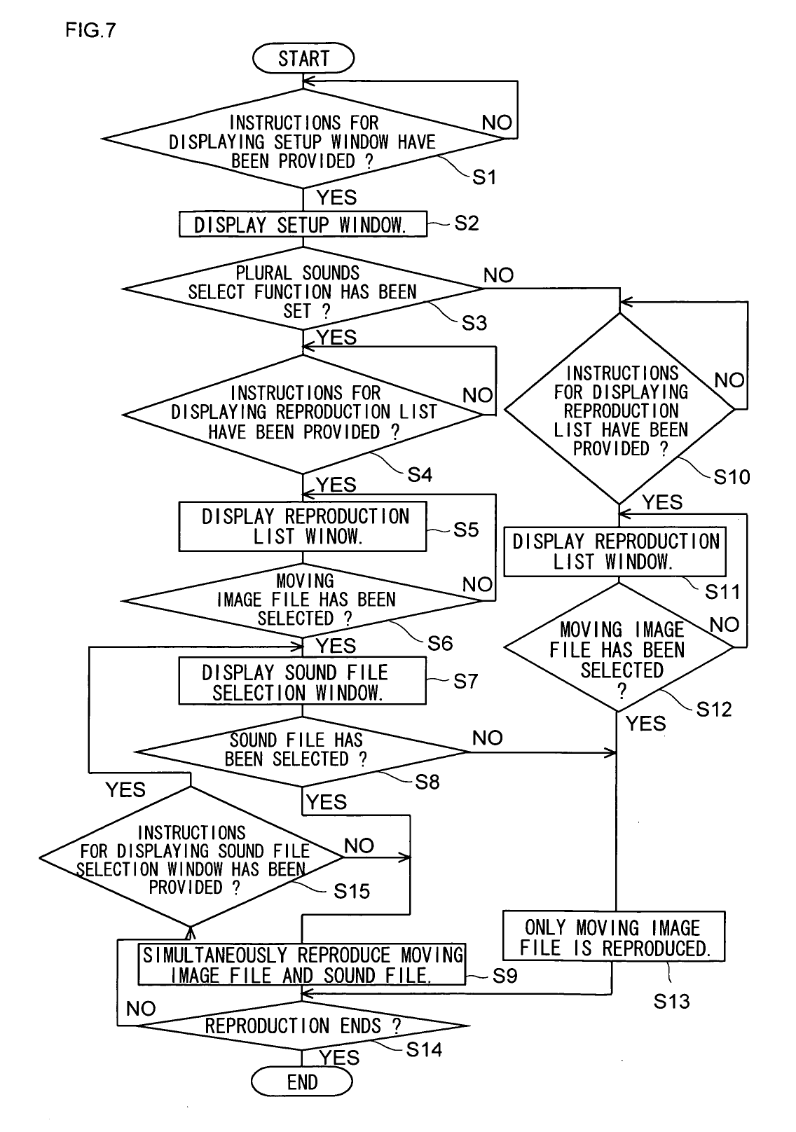

FIG. 7 is a flowchart explaining processing for reproducing a moving image file and a sound file recorded on the recording medium in the second embodiment. In FIG. 7, those corresponding to steps shown in FIG. 6 are provided with the same numerals (step numbers). Referring to this flowchart and FIGS. 1 to 5, a description will be given concerning the processing performed when the information reproduction device in this embodiment reproduces a moving image file and a sound file recorded on the recording medium.

First, to display the setup window 21 on the display device 16 of the monitor device B, the user operates the key for displaying the setup window on the operation part 11, upon which the system controller 12 detects that instructions for displaying the setup window have been provided (step S1), and displays, for example, the setup window 21 on the display device 16 of the monitor device B (step S2).

The user views the setup window 21, and in order to activate the plural sounds select function, operates the cursor key on the operation part 11 to select the “ON” button and further operates the determine key on the operation part 11. Then the system controller 12 detects that the plural sounds select function has been set (step S3).

Next, the user, in order to select a moving image file desired to be reproduced from among a plurality of moving image files recorded on the recording medium 1, operates the key for displaying the reproduction list on the operation part 11. Then the system controller 12 detects that instructions for displaying the reproduction list have been provided (step S4), reads file management information recorded on the recording medium 1, and in accordance with this file management information, displays, for example, the reproduction list window 31 on the display device 16 of the monitor device B (step S5).

Then the user views the reproduction list window 31, operates the operation part 11 to select and determine, for example, the moving image file name “MF2”, upon which the sound file selection window display part of the system controller 12 detects that the moving image file with the file name “MF2” has been selected (step S6), and when a sound file corresponding to the moving image file with the moving image file name “MF2” exists in the same holder of this moving image file, displays, for example, the sound file selection window 41 on the display device 16 (step S7).

Further, the user views the sound file selection window 41, and operates the operation part 11 to select and determine, for example, the sound file name “AF2”, upon which the simultaneous reproduction part of the system controller 12 detects that the sound file with the sound file name “AF2” has been selected (step S8), and simultaneously reproduces the aforementioned moving image file and the aforementioned selected sound file which have been selected from the recording medium 1 (step S9). Then when this reproduction ends (step S14), this processing ends.

Moreover, the user views the setup window 21, and when the user does not desire to activate the plural sounds select function, operates the cursor key on the operation part 11 to select the “OFF” button, and further operates the determine key on the operation part 11, upon which the system controller 12 detects that the plural sounds select functions has not been set (step S3).

Next, the user, in order to select the moving image file to desired be reproduced from among the plurality of moving image files recorded on the recording medium 1, operates the key for displaying the reproduction list on the operation part 11. Then the system controller 12 detects that instructions for displaying the reproduction list have been provided (step S10), reads the file management information recorded on the recording medium 1, and in accordance with this file management information, displays, for example, the reproduction list window 31 on the display device 16 of the monitor device B (step S11).

Then the user views the reproduction list window 31, and operates the operation part 11 to select and determine, for example, the moving file name “MF2”, upon which the reproduction part of the system controller 12 detects that the moving image file with the moving image file name “MF2” has been selected (step S12), and reproduces from the recording medium 1 only the moving image file with the moving image file name “MF2” (step S13). Then when this reproduction ends (step S14), this processing ends.

Moreover, in step S8, for example, the sound file name is not selected on the sound file selection window 41 (see FIG. 4), and the item “not selected” is selected by operating the cursor key on the operation part 11 and determined by operating the determine key on the operation part 11, upon which the reproduction part of the system controller 12 detects that no sound file has been selected from the sound file selection window 41 (step S8), and reproduces only the moving image file with the moving image file name “MF2” (step S13). Then when this reproduction ends (step S14), this processing ends.

There is a case where during simultaneous reproduction of a moving image file and a sound file, of the sound files recorded on the recording medium 1, another desired sound file other than the sound file currently reproduced is desired to be reproduced. Thus, the user performs operation for switching a sound file to be reproduced. Specifically, during the simultaneous reproduction of the aforementioned moving image file and the aforementioned sound file by the simultaneous reproduction part, upon detection, by the during-reproduction corresponding-sound file selection-window display part of the system controller 12, of instructions for displaying the sound file selection window (step S15), the user displays the sound file selection window 41 on the display device 16 (step S7).

Thereafter, the user views the sound file selection window 41, and operates the operation part 11, and selects and determines, for example, the sound file name “AF5”, upon which the sound file selection window 51 as shown in FIG. 5 appears, and the simultaneous reproduction part of the system controller 12 detects that the sound file with the file name “AF5” has been detected (step S8), and simultaneously reproduces the aforementioned moving image file and the aforementioned selected sound file which have been selected from the recording medium 1 (step S9). In this manner, by selecting, for example, another desired sound file other than the sound file with the sound file name “AF2” (sound file with the sound file name “AF5” as in the sound file selection window 51) in the sound file selection window 41, even during the simultaneous reproduction of the moving image file and the sound file, output sound can be switched.

With the information reproduction device of the second embodiment described above, to reproduce a moving image file without sound data, a desired sound file can be selected from among a plurality of sound files corresponding to this moving image file and then the moving image file and the sound file can be simultaneously reproduced, whereby even for a file in the file format that basically permits reproduction of only a sound file previously defined for one moving image, another desired sound file for this moving image file can be selected and reproduced, thus improving the user-friendliness.

Moreover, by selecting another desired sound file other than the desired sound file in the sound file selection window, output sound can be switched; therefore, even during simultaneous reproduction of the moving image file and the sound file, the sound file to be output can be switched, thus further improving the user friendliness.

According to the first and second embodiments described above, for example, to reproduce with a Divx file a moving image file (such as AVI or Divx) without sound data, when a sound file (such as MP3 or MP2) corresponding to this moving image file is selected, the sound file is reproduced in accordance with the moving image file. Moreover, with the Divx file, editing at the time of file creation is typically required for switching between a plurality of sounds, but the second embodiment permits sound switching by easy operation during reproduction.

The invention is applicable to information reproduction devices (DVD players, etc) capable of information reproduction from a recording medium in which at least moving image files and sound files are recorded.

What is claimed is:

1. An information reproduction device capable of information reproduction from a recording medium in which at least moving image files and sound files are recorded, the information reproduction device comprising:
a sound file selection window display part which, when plural sounds select function has been set, after detection that a desired moving image file has been selected from a reproduction list window, when there is a sound file corresponding to the desired moving image file in a same holder of the desired moving image file, displays a sound file selection window on a display device; and
a simultaneous reproduction part which, upon detection that a desired sound file has been selected from the sound file selection window displayed by the sound file selection window display part, simultaneously reproduces the selected desired moving image file and the selected desired sound file.

2. The information reproduction device according to claim 1, further comprising a during-reproduction corresponding-sound file selection-window display part which, upon detection of instructions for displaying the sound file selection window during the simultaneous reproduction of the moving image file and the sound file by the simultaneous reproduction part, displays the sound file selection window on the display device,
wherein output sound is switched by selecting another desired sound file other than the desired sound file in the displayed sound file selection window.

3. The information reproduction device according to claim 1, further comprising a reproduction part which, upon detection that no sound file has been selected from the sound file selection window displayed by the sound file selection window display part, reproduces only the selected desired moving image file.

4. The information reproduction device according to claim 1, further comprising a reproduction part, which, when the plural sounds select function has not been set, after the detection that the desired moving image file has been selected from the reproduction list window, reproduces only the selected desired moving image file.

5. The information reproduction device according to claim 2, further comprising a reproduction part which, upon detection that no sound file has not been selected from the sound file selection window displayed by the sound selection window display part, reproduces only the selected desired moving image file.

6. The information reproduction device according to claim 2, further comprising a reproduction part which, when the plural sounds select function has not been set, after the detection that the desired moving image file has been selected from the reproduction list window, reproduces only the selected desired moving image file.
